(19) United States
(12) Patent Application Publication
(10) Pub. No.: US 2014/0274001 A1
(43) Pub. Date: Sep. 18, 2014

(54) CALL CONNECTION METHOD

(71) Applicant: Electronics and Telecommunications Research Institute, Daejeon (KR)

(72) Inventors: Ji Yong KIM, Daejeon (KR); Jong Ho WON, Daejeon (KR); Ga Gue KIM, Daejeon (KR); Kyoung PARK, Daejeon (KR)

(21) Appl. No.: 13/912,320

(22) Filed: Jun. 7, 2013

(30) Foreign Application Priority Data
Mar. 14, 2013 (KR) 10-2013-0027520

(51) Int. Cl. H04M 3/436; H04W 4/16

(52) U.S. Cl. CPC H04M 3/4365; H04W 4/16
USPC 455/415

(57) ABSTRACT

A method of connecting a call by a recipient terminal includes the recipient terminal receiving a call from a caller terminal, and displaying the purpose of the call, input by a caller and included in the call, on a call reception indication screen.

### CROSS-REFERENCE TO RELATED APPLICATION

This application claims priority to and the benefit of Korean Patent Application No. 10-2013-0027520 filed in the Korean Intellectual Property Office on Mar. 14, 2013, the entire contents of which are incorporated herein by reference.

### BACKGROUND OF THE INVENTION

(a) Field of the Invention

The present invention relates to a call connection method. More particularly, the present invention relates to a call connection method capable of rejecting a frequently generated spam call.

(b) Description of the Related Art

A currently used caller identification presentation supplementary service displays a caller number on a display window of a terminal of a recipient. If the caller number is stored in the terminal of the recipient, the caller name stored in the terminal may be displayed. Accordingly, the recipient can check the caller number and determine whether to receive the call from the caller.

In case of receiving a collect call, when a caller records their voice for a short time to identify themselves, a recipient checks the recorded caller voice and determines whether to allow the call from the caller to be connected.

In this manner, conventional services focus on identification of a caller, taking no account of the purpose of call. That is, a caller requests a recipient to permit connection of a call without disclosing the purpose of the call in the conventional call connection methods.

However, when a recipient does not know a caller number, display of the caller number on the display window of the recipient is meaningless. Furthermore, while the recipient does not know the caller number, the call from the caller may be important to the recipient.

Moreover, even if the recipient recognizes the caller as an acquaintance through the caller number or when receiving a collect call, the recipient may not receive the call as necessary.

Accordingly, it is difficult to provide a service suitable for various situations of the recipient based only on identification of the caller.

### SUMMARY OF THE INVENTION

The present invention has been made in an effort to provide a call connection method having advantages of delivering the purpose of a call from a caller to a recipient to allow the recipient to accept or reject the call according to the content of the call.

According to an exemplary embodiment of the present invention, a method of connecting a call by a recipient terminal is provided. The method of connecting a call by a recipient terminal includes: the recipient terminal receiving a call from a caller terminal; and displaying the purpose of the call, input by a caller and included in the call, on a call reception indication screen.

According to another exemplary embodiment of the present invention, a method of connecting a call by a caller terminal is provided. The method of connecting a call by a caller terminal includes inputting the purpose of a call to the caller terminal and originating a call including the purpose of the call and recipient information.

According to an exemplary embodiment of the present invention, the conventional number-based call connection service focusing on identification and display of a caller is changed to a purpose-based call connection service capable of disclosing the purpose of a call from a caller such that a recipient can select connection of a call from an unregistered caller. In addition, a recipient can be aware of the content of a call from a caller before connection of the call, and thus the recipient can handle the call properly. It is desirable that the content of a call from a caller be displayed on a terminal of a recipient such that the recipient can reject connection of the call according to the content of the call even if the phone number of the caller is stored in the terminal of the recipient.

### BRIEF DESCRIPTION OF THE DRAWINGS

FIG. 1 illustrates a configuration of a call connection system according to an exemplary embodiment of the present invention.

FIG. 2 is a block diagram of a caller terminal shown in FIG. 1.

FIG. 3 is a block diagram of a recipient terminal shown in FIG. 1.

FIG. 4 is a flowchart illustrating a call connection method according to an exemplary embodiment of the present invention.

FIG. 5 is a flowchart illustrating a call connection method according to another exemplary embodiment of the present invention.

FIGS. 6 and 7 illustrate a case in which the caller terminal according to an exemplary embodiment of the present invention requests a call.

FIG. 8 illustrates a case in which the recipient terminal according to an exemplary embodiment of the present invention receives a call.

### DETAILED DESCRIPTION OF THE EMBODIMENTS

In the following detailed description, only certain exemplary embodiments of the present invention will be shown and described by way of illustration. As those skilled in the art would realize, the embodiments described below may be modified in various different ways without departing from the spirit or scope of the present invention. Accordingly, the drawings and description are to be regarded as illustrative in nature and not restrictive. Like reference numerals designate like elements throughout the specification.

In the specification and claims, unless explicitly described to the contrary, the word “comprise” and variations such as “comprises” or “comprising” will be understood to imply the inclusion of stated elements but not the exclusion of any other elements.

A call connection method according to an exemplary embodiment of the present invention will now be described in detail with reference to the attached drawings.

FIG. 1 illustrates a configuration of a call connection system according to an exemplary embodiment of the present invention, FIG. 2 is a block diagram of a caller terminal shown in FIG. 1, and FIG. 3 is a block diagram of a recipient terminal shown in FIG. 1.

Referring to FIG. 1, the call connection system includes a caller terminal 100, a recipient terminal 200, and a network 300.

The caller terminal 100 and the recipient terminal 200 are connected to the network 300. The caller terminal 100 and the recipient terminal 200 can perform voice call, video call, data communication, and text message reception.

Here, voice call and video call are implemented through a telephone network of a common carrier. Voice call and video call may be implemented through the Internet.

Text messages are provided according to a message service of a mobile communication network. For example, text messages may include an SMS (short message service) message, an MMS (multimedia message service) message, and an LMS (long message service) message.

The caller terminal 100 and the recipient terminal 200 may include a portable terminal and a smart terminal. The smart terminal represents a device having functions which are not limited and can be modified or extended through applications. The smart terminal may be a smartphone, a tablet PC, etc.

The caller terminal 100 originates a call requesting voice call or video call connection. The caller terminal 100 may be implemented as shown in FIG. 2.

Referring to FIG. 2, the caller terminal 100 includes a communication unit 101, a memory 103, a display 105, an input unit 107, and an origination processor 109.

The communication unit 101 is connected to the origination processor 109 and the network 300 to transmit/receive data. The communication unit 101 may include a baseband circuit for transmitting/receiving data.

The memory 103 is connected to the origination processor 109 and stores information used to drive the origination processor 109. The memory 103 may be implemented as a dynamic random access memory (DRAM), rambus DRAM (RDRAM), synchronous DRAM (SDRAM), static RAM (SRAM), etc. The memory 103 may be disposed inside or outside the origination processor 109 and connected to the origination processor 109 through various known means.

The display 105 is disposed outside the caller terminal 100 and connected to the origination processor 109 to display information according to operation of the origination processor 109 on a screen thereof. A commercially available LCD (liquid crystal display) may be used as the display 105.

The input unit 107 is an input interface of a user and may include a pointing device such as an optical joystick, touchpad, Hall sensor, fingerprint sensor, pressure sensor, etc., and a keypad and a touch screen. Various input means may be employed as the input unit 107.

The origination processor 109 originates a call requesting voice call or video call connection. When the origination processor 109 originates the call, the origination processor 109 transmits the purpose of the call, input by the caller, along with the number of a recipient.

Upon reception of the call, the recipient terminal 200 transmits a call connection response or a call rejection response. The recipient terminal 200 may be implemented as shown in FIG. 3.

Referring to FIG. 3, the recipient terminal 200 includes a communication unit 201, a memory 203, a display 205, an input unit 207, and a reception processor 209.

The communication unit 201 is connected to the reception processor 209 and the network 300 to transmit/receive data. The communication unit 201 may include a baseband circuit for transmitting/receiving data.

The memory 203 is connected to the reception processor 209 and stores information used to drive the reception processor 209. The memory 203 may be implemented as a medium such as a RAM including DRAM, RDRAM, SDRAM, SRAM, etc. The memory 203 may be disposed inside or outside the reception processor 209 and connected to the reception processor 209 through various known means.

The display 205 is disposed outside the recipient terminal 200 and connected to the reception processor 209 to display information according to operation of the reception processor 209 on a screen thereof. A commercially available LCD may be used as the display 205.

The input unit 207 is an input interface of a user and may include a pointing device such as an optical joystick, touchpad, hall sensor, fingerprint sensor, pressure sensor, etc., and a keypad and a touch screen. Various input means may be employed as the input unit 107.

The reception processor 209 receives a call. That is, the reception processor 209 receives a call requesting voice call or video call connection. The reception processor 209 transmits a call connection response or a call rejection response according to user input.

Here, the reception processor 209 outputs the phone number of the caller who originates the received call and the purpose of the call input by the caller to a call reception screen.

Furthermore, when the caller number is stored in a phonebook (not shown), the reception processor 209 outputs a stored name corresponding to the caller number and the purpose of the call.

The network 300 provides a transmission/reception path through which voice call, video call, data, and text messages are transmitted/received, and includes an exchange (not shown), message server (not shown), and service provider server (not shown) providing an Internet call service.

The network 300 includes a mobile communication network such as a WCDMA (wideband code division multiple access) network, HSDPA (high speed downlink packet access) network, LTE (long term evolution) network, or WiBro network, WiFi network, or wireless local area network (WLAN). However, the network 300 is not limited thereto.

FIG. 4 is a flowchart illustrating a call connection method according to an exemplary embodiment of the present invention.

Operations of the caller terminal 100 and recipient terminal 200 will be described in connection with the configurations of FIGS. 2 and 3 using the same reference numerals. A call connection server (not shown) is included in the network 300 and refers to a component that implements voice call and video call through a telephone network.

Referring to FIG. 4, the caller terminal 100 receives the purpose of a call and a recipient number from a caller (S101). Specifically, the origination processor 109 receives the purpose of the call, input by the caller, and the recipient number, that is, the number of the recipient terminal 200, from the input unit 107 (S101).

The caller terminal 100 transmits a call requesting call connection to the call connection server (not shown) of the network 300 according to user input (S103). Specifically, upon reception of a user input signal requesting call connection from the input unit 107, the origination processor 109 originates the call including the number of the caller terminal 100, that is, caller number, the purpose of the call input in step S101, and the recipient number.

The call connection server (not shown) confirms the recipient number from the call originated in step S103 and transmits the call to the recipient terminal 200 corresponding to the recipient number (S105).

Then, the recipient terminal 200 displays the purpose of the call and the caller number on the screen thereof (S107). Specifically, the reception processor 209 displays the purpose of the call and the caller number included in the call received in step S105 on the screen of the display 205.

Then, the recipient terminal 200 determines whether the call is connected or rejected according to user input. Specifically, the reception processor 209 determines whether a user input signal permitting call connection or a user input signal rejecting the call is transmitted from the input unit 107.

Upon determining that the call is connected, the recipient terminal 200 transmits a call connection response to the call connection server (not shown) (S111). Then, the call connection server (not shown) performs call connection between the caller terminal 100 and the recipient terminal 200 (S113).

Upon determining that the call is rejected, the recipient terminal 200 transmits a call rejection response to the call connection server (not shown) (S115) and ends call connection (S117).

The call connection server (not shown) transmits the call rejection response to the caller terminal 100 (S119). Then, the caller terminal 100 completes call connection (S121).

FIG. 5 is a flowchart illustrating a call connection method according to another exemplary embodiment of the present invention, which shows call connection through the Internet. For example, call connection illustrated in FIG. 5 includes call connection through an Internet call service and a voice talk service through a mobile messenger service.

In this case, operations of the caller terminal 100 and recipient terminal 200 are described in connection with the configurations of FIGS. 2 and 3 using the same reference numerals and parts corresponding to those illustrated in FIG. 4 are briefly described.

Referring to FIG. 5, the caller terminal 100 receives the purpose of a call and a recipient number (S201).

The caller terminal 100 originates a call requesting Internet call connection to a service provider server (not shown) of the network 300 according to user input (S203). Here, the service provider server (not shown) is provided by an Internet call service provider providing an Internet call service.

In this case, the call may include caller ID and recipient ID instead of phone numbers, and the purpose of the call. Otherwise, the call may include a caller nickname, a recipient nickname, and the purpose of the call.

The service provider server (not shown) confirms the recipient number from the call received in step S203, and transmits the call to the recipient terminal 200 corresponding to the recipient number (S205).

Then, the recipient terminal 200 displays the content of the call and the caller number on the screen thereof (S207). Here, caller ID or caller nickname instead of the caller number and the purpose of the call may be displayed on the screen.

The recipient terminal 200 determines whether the call is connected or rejected according to user input (S209).

Upon determining that the call is connected, the recipient terminal 200 transmits a call connection response to the service provider server (not shown) (S211).

Then, the service provider server (not shown) transmits a call connection request including the caller number and the recipient number to the call connection server (not shown) (S213).

The call connection server (not shown) performs call connection between the caller terminal 100 and the recipient terminal 200 (S215).

Upon determining that the call is rejected, the recipient terminal 200 transmits a call rejection response to the service provider server (not shown) (S217) and ends call connection (S219).

The service provider server (not shown) transmits the call rejection response to the caller terminal 100 (S221). Then, the caller terminal 100 finishes call connection (S223).

FIGS. 6 and 7 illustrate a case in which the caller terminal according to an exemplary embodiment of the present invention requests a call.

Referring to FIG. 6, when a caller inputs a recipient number, 010-3310-25 . . . , and selects or clicks a ‘next’ button P1, the recipient number input step is switched to a step of inputting the purpose of a call.

That is, an input operation for switching to the step of inputting the purpose of a call is performed, distinguished from the conventional procedure in which a ‘call’ button is pressed after a recipient number is input.

Here, the input operation is not limited to the operation of selecting or clicking the ‘next’ button P1, and may be performed in various exemplary embodiments. For example, a ‘next/call’ button (not shown) used to request a call and input of the purpose of the call may be added to the caller terminal 100, and is discriminated from the ‘call’ button used to request only a call without input of the purpose of the call.

Referring to FIG. 7, a screen for inputting the purpose of a call is displayed. When the caller inputs ‘This is about a condo reservation. Check date . . . ’ and then selects or clicks a ‘call’ button P2, the caller terminal 100 originates a call including the purpose of the call.

Here, the caller may call up commonly used words stored in the caller terminal and automatically input the words instead of directly inputting the purpose of the call.

If the caller selects or clicks the ‘call’ button without inputting any word, the caller terminal 100 performs the same operation as the conventional call connection operation.

The caller terminal 100 can request a call after the recipient number is input and then the purpose of the call is input. Otherwise, the caller terminal 100 can request a call after the purpose of the call is input first and then the recipient number is input.

FIG. 8 illustrates a case in which the recipient terminal according to an exemplary embodiment of the present invention receives the call.

Referring to FIG. 8, upon reception of the call, the recipient terminal 200 displays a call reception screen. When the caller corresponding to the received call is not registered, the recipient terminal 200 displays ‘unknown caller’ instead of the caller number. However, the caller number may be displayed. In addition, the recipient terminal 200 displays a message representing the purpose of the call, input by the caller. That is, the recipient terminal 200 displays “This is about a condo reservation. I want to check the date.”

The recipient terminal 200 displays a user interface for ‘accept’ or ‘reject’ of call connection. Here, various schemes can be employed as the user interface for selecting call connection or call rejection.

When the recipient selects ‘accept’, the recipient terminal 200 transmits a call connection response and performs call connection. When the recipient selects ‘reject’, the recipient terminal 200 transmits a call rejection response and finishes call connection.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of connecting a call by a recipient terminal, comprising:
the recipient terminal receiving a call from a caller terminal; and
displaying the purpose of the call, input by a caller and included in the call, on a call reception indication screen.

2. The method of claim 1, further comprising, after the displaying of the purpose of the call:
determining whether the call is connected or rejected according to user input;
transmitting a call connection response to the caller terminal upon selection of call connection; and
transmitting a call rejection response to the caller terminal upon selection of call rejection.

3. The method of claim 2, wherein the displaying of the purpose of the call comprises displaying a user interface through which a recipient selects call connection or call rejection on the call reception indication screen.

4. The method of claim 3, wherein the displaying of the purpose of the call comprises:
if caller information included in the call corresponds to information registered in a phonebook of the recipient terminal, displaying a corresponding name registered in the phonebook and the purpose of the call; and
displaying a message ‘unknown caller’ or the caller number and the purpose of the call if the caller information included in the call is not registered in the phonebook of the recipient terminal.

5. A method of connecting a call by a caller terminal, comprising:
inputting the purpose of a call to the caller terminal; and
originating a call including the purpose of the call and recipient information.

6. The method of claim 5, further comprising, after the originating of the call:
performing call connection with a recipient terminal upon reception of a call connection response from the recipient terminal; and
finishing call connection upon reception of a call rejection response from the recipient terminal.

7. The method of claim 6, wherein the inputting of the purpose of the call comprises:
inputting or selecting the recipient information;
instructing the purpose of the call to be input when a predetermined user input operation is performed; and
inputting the purpose of the call.

8. The method of claim 6, wherein the predetermined user input operation comprises an operation of selecting or clicking a call button included in the recipient terminal, the call button including a function of inputting the purpose of a call.

9. The method of claim 6, wherein the inputting of the purpose of the call comprises inputting the purpose of the call and the recipient information and selecting or clicking a call button, and the originating of the call comprises originating the call when the call button is selected or clicked.
